(19) United States
(12) Patent Application Publication
(10) Pub. No.: US 2025/0348941 A1
(43) Pub. Date: Nov. 13, 2025

(54) ARTIFICIAL INTELLIGENCE-BASED IMAGE ANALYSIS FOR DATA ALLOCATION

(71) Applicant: SAFEGUARD PROPERTIES MANAGEMENT, LLC, Valley View, OH (US)

(72) Inventors: Michael GREENBAUM, Hudson, OH (US); Elizabeth SQUIRES, Moreland Hills, OH (US)

(73) Assignee: SAFEGUARD PROPERTIES MANAGEMENT, LLC, Valley View, OH (US)

(21) Appl. No.: 19/202,900

(22) Filed: May 8, 2025

Related U.S. Application Data
(60) Provisional application No. 63/731,512, filed on May 13, 2024.

(51) Int. Cl. G06Q 40/06; G06T 7/00; G06V 10/764; G06V 20/70

(52) U.S. Cl. CPC G06Q 40/06; G06T 7/0002; G06V 10/764; G06V 20/70; G06T 2207/20081; G06T 2207/30184

(57) ABSTRACT

Disclosed herein are methods and systems that use artificial intelligence techniques for determining an allocation of an asset based, at least in part, on analyzing electronic images of the asset. In an embodiment, an AI model can be executed on a received data packet comprising a set of electronic images to generate a set of attributes. In an embodiment, the AI model can identify a segment of the asset associated with the electronic image, generate an attribute comprising a description of quality of the segment of the asset, and determine whether the electronic image is associated a subset of the electronic images. In an embodiment, the set of attributes and an indication of the subset with user input about the asset can be aggregated to generate evaluation data. In an embodiment, a computer model can be executed to determine an allocation of the asset to a class.

### CROSS REFERENCE TO RELATED APPLICATIONS

The present application claims priority to U.S. Provisional Patent Application No. 63/731,512, filed May 13, 2024, which is incorporated herein by reference in its entirety for all purposes.

### TECHNICAL FIELD

The present disclosure generally relates to asset allocation and management, including but not limited to artificial intelligence-based image analysis techniques for evaluation of data packets.

### BACKGROUND

Routing data packages corresponding to different assets to different computing entities presents several technical challenges that arise from the heterogeneity, scale, and timing sensitivities inherent in the property disposition workflow. First, each data packet may be associated with a unique set of stakeholders, each operating on distinct computing systems with varying formats, APIs, authentication mechanisms, and service-level protocols. Ensuring secure, accurate, and real-time communication between the asset allocation system and these disparate partner computing systems requires robust routing logic, dynamic endpoint resolution, and fault-tolerant data transmission protocols. Moreover, the data packages themselves may contain sensitive or time-critical information, and routing errors could result in noncompliance. Additionally, maintaining stateful awareness of which packages belong to which properties, especially at high volumes, requires sophisticated message queueing, metadata tagging, and priority-based orchestration mechanisms. These complexities make the reliable, automated routing of data packages a non-trivial technical problem that requires coordinated system design and advanced data infrastructure.

### SUMMARY

For the aforementioned reasons, there is a desire for methods and systems that can allocate data packets corresponding to assets, such as properties, to classes that represent disposition channels for the properties based on analysis of electronic images included in the data packets. Methods and systems described herein provide a trained vision language model for identifying impediments of a property based on a set of electronic images of the property. Based on the impediments, the methods and system can allocate the property to a class and manage tasks associated with the class.

Using the methods and systems discussed herein, an asset allocation system can execute the vision language model in conjunction with a large language model (LLM) trained to generate text prompts for the vision language model. The vision language model can be trained to identify deficiencies in the electronic images and generate text output indicting the deficiencies present in the electronic images. The deficiencies can indicate portions of the property that are out of standard of a disposition channel and therefore represent an impediment to that disposition channel. In an example, each of the electronic images can be associated with predefined segments of the property, and the vision language model may be trained to identify common deficiencies for these segments. Once deficiencies have been identified, a list of impediments may be generated for at least one of the disposition channels. The list can indicate repairs that would be performed on the property to make it eligible for the disposition channel and associated costs of repairs. The list of impediments can be aggregated with user input indicating values associated with the property, such as an appraisal value or a value of the foreclosed upon loan to generate evaluation data. Based on the evaluation data, a statistical model can generate a value for each disposition channel, which can be used to allocate the property to a disposition channel. The asset allocation system can then route data packets associated with tasks to partner systems based on the disposition channel that the property has been allocated to. For example, the tasks can be associated with partner systems representing external entities that are involved in the tasks. The system can use application programming interface (API) connectivity to request and retrieve data from partner systems based on service level agreements (SLA). SLAs can serve as predefined agreements governing interactions between the asset allocation system and partner systems. These agreements can outline key aspects of the interactions, such as response metrics and data accessibility.

The described system can improve the efficiency of retrieving and transmitting information to partner systems. For example, the API connectivity according to SLAs can be used to efficiently retrieve and transmit data in a variety of formats according to predefined agreements. As an example, the asset allocation system may efficiently retrieve information including cost of repairing deficiencies, possible selling prices of the property, and/or the like from partner systems with predefined consent for access to the information from the SLA. As another example, the asset allocation system may efficiently trigger workflows associated with tasks to partner systems. This can enable the system to efficiently handle extensive data interactions across a diverse range of data management systems and formats utilized by partner systems.

The system may also standardize allocation determinations. For example, by executing the vision language model and/or prompt model trained to generate output based on the predefined segments, the asset allocation system may provide consistent identification of deficiencies that commonly occur at the predefined segments. Furthermore, coordination of data may make the process susceptible to unintended variations. For example, unintended variations in parameters (e.g., default values, methods of calculation, and/or the like) used to determine values associated with disposition channels may be present in current systems and methods. The described asset allocation system can provide a standardized pipeline for ingesting data associated with a property and generating a determination of an allocation to a disposition channel.

In one embodiment, a method may include receiving, by at least one processor, a data packet comprising a set of electronic images associated with an asset; executing, by the at least one processor, a machine learning model to ingest the set of electronic images and generate a set of attributes, wherein the machine learning model is configured to, for each electronic image in the set of electronic images: identify a segment of the asset associated with the electronic image; generate, based on the electronic image, an attribute comprising a description of quality of the segment of the asset; and determine, based on the attribute, whether the electronic image is associated a subset of the electronic images; aggregating the set of attributes and an indication of the subset with user input about the asset to generate evaluation data; executing a computer model to determine an allocation of the asset to a class of a set of classes based on the evaluation data; determining, by the at least one processor, based on the class, a task of the class to be executed; and routing, by the at least one processor, the task and the data packet to an electronic computing device associated with the task.

Generating the attribute may further include generating, based on the electronic image and the prompt, an output; and providing the output to a large language model to cause the large language model to generate the attribute.

The attribute may include a text string indicating a deficiency of the asset associated with the electronic image.

The method may further include identifying an application programming interface (API) endpoint of an API that associated with the electronic computing device; and transmitting an API call including the data packet that triggers a series of predefined actions associated with the task at the electronic computing device.

The method may further include receiving a selection of the task associated with the electronic computing device; accessing the electronic computing device via an API call to an API of the electronic computing device; and receiving an API response to the API call comprising a status representing a completion progress of the task.

The method may further include generating a graphical user interface (GUI) displaying the allocation of the asset to the class; and displaying the GUI on a user device.

The GUI may include an allocation value, generated by the computer model based on the evaluation data, associated with each class of the set of classes.

In another embodiment, a computer-readable medium storage may include a set of non-transitory instructions, that when executed, cause a processor to: receive a data packet comprising a set of electronic images associated with an asset; execute a machine learning model to ingest the set of electronic images and generate a set of attributes, wherein the machine learning model is configured to, for each electronic image in the set of electronic images: identify a segment of the asset associated with the electronic image; generate, based on the electronic image, an attribute comprising a description of quality of the segment of the asset; and determine, based on the attribute, whether the electronic image is associated a subset of the electronic images; aggregate the set of attributes and an indication of the subset with user input about the asset to generate evaluation data; execute a computer model to determine an allocation of the asset to a class of a set of classes based on the evaluation data; determine, based on the class, a task to be executed; and route the task and the data packet to an electronic computing device associated with the task.

The set of instructions may further cause the processor to generate, by the machine learning model based on the electronic image and the prompt, an output; and provide the output to a large language model to cause the large language model to generate the attribute.

The attribute may include a text string indicating a deficiency of the asset associated with the electronic image.

The set of instructions may further cause the processor to identify an application programming interface (API) endpoint of an API that associated with the electronic computing device; and transmit an API call including the data packet that triggers a series of predefined actions associated with the task at the electronic computing device.

The set of instructions may further cause the processor to receive a selection of the task associated with the electronic computing device, wherein the electronic computing device is associated with an application programming interface (API); access the electronic computing device via an API call to the API; and receive an API response operation to the API call comprising a status representing a completion progress of the task.

The set of instructions may further cause the processor to generate a graphical user interface (GUI) displaying the allocation of the asset to the class; and display the GUI on a user device.

The GUI may include an allocation value, generated by the computer model based on the evaluation data, associated with each class of the set of classes.

In another embodiment, computer system may include a machine learning model; a computer model; and a processor in communication with the machine learning model and the computer model, the processor configured to: receive a data packet comprising a set of electronic images associated with an asset; execute the machine learning model to ingest the set of electronic images and generate a set of attributes, wherein the machine learning model is configured to, for each electronic image in the set of electronic images: identify a segment of the asset associated with the electronic image; generate, based on the electronic image, an attribute comprising a description of quality of the segment of the asset; and determine, based on the attribute, whether the electronic image is associated a subset of the electronic images; aggregate the set of attributes and an indication of the subset with user input about the asset to generate evaluation data; execute the computer model to determine an allocation of the asset to a class of a set of classes based on the evaluation data; determine, based on the class, a task to be executed; and route the task and the data packet to an electronic computing device associated with the task.

The processor may be further configured to generate, by the machine learning model based on the electronic image and the prompt, an output; and provide the output to a large language model to cause the large language model to generate the attribute.

The attribute may include a text string indicating a deficiency of the asset associated with the electronic image.

The processor may be further configured to identify an application programming interface (API) endpoint of an API that associated with the electronic computing device; and transmit an API call including the data packet that triggers a series of predefined actions associated with the task at the electronic computing device.

The processor may be further configured to: receive a selection of the task associated with the electronic computing device, wherein the electronic computing device is associated with an application programming interface (API); access the electronic computing device via an API call to the API; and receive an API response to the API call comprising a status representing a completion progress of the task.

The processor may be further configured to generate a graphical user interface (GUI) displaying the allocation of the asset to the class; and display the GUI on a user device.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1 illustrates a system for determining allocations of assets, according to an embodiment.

FIG. 2 illustrates a flow diagram of determining allocations of assets, according to an embodiment.

FIGS. 3A-3E show illustrative diagrams of graphical user interfaces that may be displayed in connection with allocation of an asset, according to an embodiment.

FIG. 4 illustrates a flow process for determining allocations of assets, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. A Iterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Foreclosures of properties may occur as a result of various activities, such as default on loan payments or violation of loan terms. After a property has been foreclosed upon, several disposition channels may be available, such as Federal Housing Administration (FHA) conveyance or putting the property up for auction. However, determining a value associated with each disposition channel can include coordinating data from a variety of sources, maintaining compliance with deadlines set by the FHA, and evaluating a property to determine impediments associated with aspects of the property that are not in condition for conveyance. The impediments can be associated with damaged parts of the property and are often identified from reviewing large sets of images of the property. The value of disposition channels can depend on several factors, including a cost of repairing the impediments. Accurately evaluating the value of disposition channels can therefore require coordination of large amounts of data.

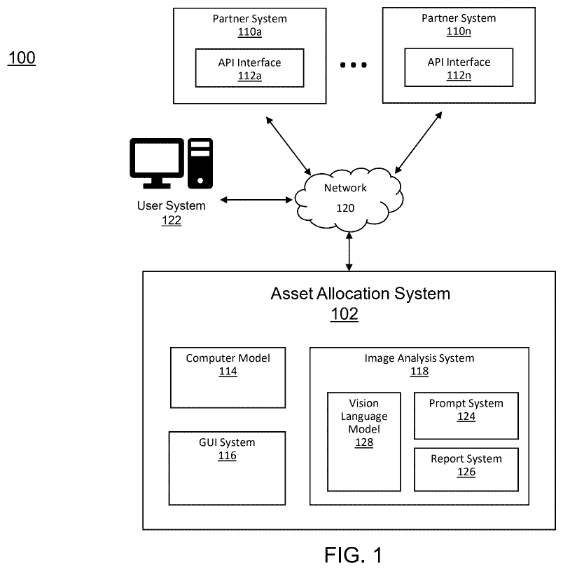

FIG. 1 illustrates a system for determining an allocation of an asset, according to an embodiment. The system 100 may include a user system 122 partner systems 110, network 120, and asset allocation system 102. The partner systems 110 can include partner systems 110a through 110n, which can each be associated with API interfaces 112 including API interface 112a through 112n. Asset allocation system 102 can include computer model 114 GUI system 116, image analysis system 118, vision language model 128, prompt system 124, and report system 126. The system 100 is not confined to the components described herein and may include additional or other components not shown for brevity, which are considered within the scope of the embodiments described herein.

The above-mentioned components may be connected through a network 120. Examples of the network 120 may include, but are not limited to, private or public LAN, WLAN, MAN, WAN, and the Internet. The network 120 may include wired and/or wireless communications according to one or more standards and/or via one or more transport mediums.

The communication over the network 120 may be performed in accordance with various communication protocols such as Transmission Control Protocol and Internet Protocol (TCP/IP), User Datagram Protocol (UDP), and IEEE communication protocols. In one example, the network 120 may include wireless communications according to Bluetooth specification sets or another standard or proprietary wireless communication protocol. In another example, the network 120 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture that can be used to determine an allocation of an asset. Specifically, as depicted in FIG. 1 and described herein, the asset allocation system 102 can receive a request to allocate an asset from the user system 122. The asset allocation system 102 can receive asset information from the user system 122. The first set of asset information can include electronic images of the asset and other asset details such as current valuation of the asset, current deficiencies of the asset, and/or the like. The asset allocation system 102 may interact with partner systems 110 via API interfaces 112 to retrieve further asset information or submit requests for tasks related to a class.

The term asset can refer to any resource that can be owned. An asset may be a physical object that has economic value. As an example, the asset may be a property, vehicle, and/or the like. In an example, the quality of the asset can be determined, at least partially, based on electronic images of the asset. For example, electronic images can capture defects of the asset. The term allocation can refer to allocating the asset to a class. As an example, classes can be route of actions (e.g., disposition channels) for a property that has been foreclosed upon. In this example, allocations can include Federal Housing Administration (FHA) conveyance, auctioning the property through Conveyance Without Clearance of Title (CWCOT), selling the property as a Real Estate Owned (REO) asset, and/or the like. The different classes can have different requirements. For example, an auctioned property may be sold as is while a property sold by a realtor may typically be repaired to a certain level, to pass certain inspections. As another example, FHA conveyance may have specific requirements associated with deadlines related to foreclosure dates that are to be met for the asset to qualify for conveyance. FHA conveyance can involve legal transfer of a property (e.g., asset) to the FHA after a foreclosure of the property and can be associated with guidelines for mortgage that was foreclosed on and the condition of the associated property. M any of these guidelines can include deadlines specifying the timeframe from default on the loan within which they are to be completed to comply with FHA requirements. In some examples, failing to meet one or more guidelines can make a property ineligible for conveyance. As an example, failing to perform necessary repairs within a specified timeframe can make the property ineligible for FHA conveyance. Managing deadlines for classes can therefore be crucial for maintaining options for allocation of an asset. Furthermore managing tasks associated with classes can involve transmitting data to a plurality of partner systems 110 associated with tasks of classes, such as insurance, property repair, expense claims, and/or the like. The described system can provide a system for managing tasks and deadlines associated with classes, such as FHA conveyance, upon the foreclosure of a property and generating a recommendation of an allocation of the property to a class. While the described systems and methods are described in relation to assets that are properties and classes such as FHA conveyance, no limitation of the scope of the claims is intended. For example, described systems and methods may be applied to routing data packets associated with a wide variety of assets, such as vehicles, appliances, and/or the like. Additionally, the systems and methods may be applied to routing data packets associated with a wide variety of standards. These can include quality standards set by the United States Department of Agriculture (USDA), property standards set by private-label Mortgage Servicing Rights (M SRs), property standards (e.g., facility standards) set by the Department of Veterans Affairs (VA), property standards set by Government-Sponsored Enterprises (GSEs) (e.g., Fannie Mae), and/or the like. In an example, disposition parameters within the computer model 114 can include configurable parameters that can be tuned to each type of standards. Additionally, the vision language model 128 can be fine-tuned on a dataset including images and/or descriptions that are specific to the targeted standards.

The user system 122 can be a device configured to receive requests to determine an allocation of an asset. For example, the user system 122 may be a device (e.g., laptop, mobile device, and/or the like) that receives a request to determine an allocation of an asset and/or asset information associated with the asset. The request can include a data packet including electronic images and/or user input associated with the asset. For example, the electronic images may each be associated with a segment of the asset. Segments can be portions of the asset. As an example, segments of a property can be a fireplace, front door, kitchen, gutter, roof, and/or the like. In some examples, the request may include asset data (e.g., user input) associated with the asset and/or classes. In an example, the asset data can include data about the asset. As an example, the asset data can include an unpaid principal balance of a foreclosed upon mortgage, location of the asset, current valuation (e.g., determined by an appraiser), and/or the like. In another example, the asset data can also include parameters for determining the recommended allocation. For example, the computer model 114 that determines the allocation of the asset can include a set of parameters, which the user may modify. These parameters can include a sales and marketing cost, an estimated time the asset will take to sell, and/or the like. In this example, the computer model 114 may include a default value for parameters and/or generate a parameter value based on asset data. In an example, the request can include a specified value for one or more parameters (e.g., to be used instead of default or generated value). In some examples, the user system 122 can generate a graphical user interface (GUI) in these examples, the user system 122 may receive the request and associated selections via the GUI.

The partner systems 110 can be service providers that are associated with tasks of at least one class. Partner systems 110 can include a plurality of partner systems (e.g., partner system 110a through partner system 110n) that can each provide a functionality associated with one or more evaluation methods. As an example, partner systems 110 can provide services associated with putting the asset up for auction, insurance claims, property repairs, processing expense claims, and/or the like. In an example, partner systems 110 can also include HUD auditors that may audit compliance with standards and regulations for FHA conveyance. In some examples, the partner systems 110 can be accessed via API interfaces 112. For example, each of partner system 110a through partner system 110n can be associated with API interface 112a through API interface 112n, respectively. For example, the partner systems 110 can receive API calls including requests for data from the asset allocation system 102 via the API interfaces 112. In some examples, actions can be triggered to the partner systems 110 as a workflow. For example, a task (e.g., associated with an impediment) that has been identified may be triggered to an appropriate partner system of the partner systems 110 as a series of automated actions (e.g., to setup the task in the partner system). In this example, the partner system may transmit a status update associated with the task, which can be reflected in a GUI generated by the GUI system 116. In an example, a partner system of the partner systems 110 may not be associated with an API interface of API interfaces 112. For example, the asset allocation system 102 may transmit or request data via an email. The email can include a link to a GUI associated with the asset allocation system 102. The partner system may view and/or edit data via this GUI.

In some examples, data can be exchanged between the asset allocation system 102 and the partner systems 110 according to service level agreements (SLAs). The SLAs can define data exchange between the partner systems 110 and the asset allocation system 102. For example, the SLAs can be formal agreements between the partner systems 110 and the asset allocation system 102 that define conditions of services provided. In an example, the SLAs can be associated with data exchange. In this example, the SLAs may define access of the asset allocation system 102 to data, performance of API interfaces 112 and/or the like. For example, the API interfaces 112 can determine that the asset allocation system 102 has previously been given permission to access certain types of data based on the SLAs. Based on this determination, the API interfaces 112 can provide the data in response to a request submitted by the asset allocation system 102 (e.g., without the partner system 110). In another example, the SLA s may define conditions of services provided by partner systems 110. For example, the asset allocation system 102 can determine which partner system 110 provides certain services based on the SLAs. In some examples, the asset allocation system 102 can determine a value (e.g., cost) of a task based on the SLAs. For example, the asset allocation system 102 can determine a cost to fix an identified deficiency of the asset based on the SLAs. The cost can be determined based on an SLA associated with a partner system of partner systems 110 that provides repair services. In this example, the asset allocation system 102 can determine a cost of a class based, at least in part, on the SLAs. In some examples, the SLAs can be associated with a validity time period. For example, an SLA may define a time period that the value is valid for.

In some examples, the asset allocation system 102 can perform access logging of interactions with the partner systems 110. For example, the asset allocation system 102 may log transmissions (e.g., API calls) to the partner systems 110 and actions of the partner systems 110 within the asset allocation system 102. As an example, partner systems 110 may access a platform presented by the asset allocation system 102 to update a status of a task. The asset allocation system 102 may log which partner system 110 accessed the asset allocation system 102, a user that accessed the asset allocation system 102 (e.g., the user and/or role of the user), which files and systems within the asset allocation system 102 were accessed, and/or an access time. In this example, access to part or all of the asset allocation system 102 may be permitted based on a role and/or associated partner system of a user. For example, the asset allocation system 102 may limit access to certain files and/or systems based on the role associated with the user. In some examples, the asset allocation system 102 may log interactions with HUD reviewers. For example, a HUD reviewer may request access to the asset allocation system 102 for audit procedures. In this example, the HUD reviewer may access the asset allocation system 102 to ensure compliance with regulations. The asset allocation system 102 may log which files and/or systems have been accessed by the reviewer.

The asset allocation system 102 can be a system for determining recommended classes and managing tasks associated with classes. For example, the asset allocation system 102 can be configured to receive a request to recommend an allocation of an asset from the user system 122. For example, the asset allocation system 102 may receive a request to predict a recommendation of an allocation of the asset from the user system 122. The request can include electronic images. In an example, the request may also include asset data. The asset allocation system 102 may identify one or more deficiencies of the asset based on the electronic images. For example, the asset allocation system 102 may generate attributes describing the electronic images using the vision language model 128. Based on these attributes, the asset allocation system 102 can identify which electronic images indicate deficiencies within the asset. The deficiencies can be quality conditions of the asset, such as areas that may need repair and/or do not comply with standards (e.g., such as standards associated with FHA conveyance). In an example, the asset allocation system 102 may interact with one or more of the partner systems 110 to determine a value (e.g., cost) of rectifying the identified deficiencies. The asset allocation system 102 can then execute the computer model 114 to generate a value associated with each possible class. The values associated with classes may be net present values (NPV) representing the expected costs subtracted from the expected selling price of the asset in that class. Based on the values associated with the classes, the computer model 114 can determine an allocation of the asset. For example, the computer model 114 may determine the class with the highest value (e.g., NPV) to be the class.

Additionally, or alternatively, the request received from the user system 122 can be a request to manage tasks of classes associated with the asset. For example, the request can be a request that is associated with a task from one of the partner systems 110. The request can be a request to notify partner systems 110 of an upcoming deadline, request an update on a status of a task, request information related to services provided by partner systems 110, and/or the like. In some examples, the message may be automated based on guidelines associated with a class. For example, in response to determining that the deadline for performing a first inspection is within a threshold number of days (e.g., the deadline is a week away), the asset allocation system 102 can transmit a message to the vendor associated with performing inspections. In some examples, the asset allocation system 102 may maintain a record of requests input by the user system 122. For example, previous requests for updates on a task can be provided to the user system 122 (e.g., as part of the graphical user interface).

The image analysis system 118 can analyze the asset based on the electronic images. For example, the image analysis system 118 can use the prompt system 124 to prompt the vision language model 128 to generate output describing the asset. In this example, the vision language model 128 can generate output based on the prompt provided by the prompt system 124. In some examples, the report system 126 may compile output from the vision language model 128. For example, the report system 126 can generate a report identifying a subset of the electronic images that are associated with deficiencies. Deficiencies can refer to issues that can affect the condition and/or value of a property. In some examples, deficiencies may need to be resolved before the asset is eligible for one or more classes. For example, FHA conveyance defines standards for a property to be eligible for conveyance (e.g., functional utilities, free of debris, and/or the like). In an example, the report system 126 can compile a report, based on the output generated by the vision language model 128, indicating a set of deficiencies of the asset. The image analysis system 118 may thereby identify deficiencies of the asset and a subset of electronic images associated with these deficiencies based on the output of the vision language model 128 and/or report system 126.

In some examples, segments of the asset may be predefined. For example, each segment can be associated with a station around a property. In this example, the stations may be portions of the property, such as the fireplace, roof, kitchen, backyard, and/or the like). The image analysis system 118 may be configured to identify deficiencies at the predefined stations (e.g., predefined segments). The received electronic images may be captured according to the predefined stations. In some examples, the received electronic images may not include some stations. For example, a property may not include a fireplace, therefore the electronic images may not include an image of a fireplace. Similarly, the electronic images may be associated with portions of the property that the image analysis system 118 has been configured to identify. In this example, the image analysis system 118 may identify that the electronic image is not associated with a predefined segment.

In some examples, the image analysis system 118 may verify authenticity of received electronic images. For example, electronic images may be associated with metadata (e.g., global positioning system (GPS metadata), timestamps, and/or the like). The metadata may be embedded into the electronic image. In response to determining that the metadata does not match an attribute of the asset, the image analysis system 118 may indicate that the electronic images may not be authentic. For example, in response to determining that the GPS metadata embedded in an electronic image is not within a threshold distance of an address associated with the asset, the image analysis system 118 may indicate that the electronic image may not be authentic. In an example, images that are marked as possibly not authentic may be marked for further review (e.g., by a human reviewer). In this example, the asset allocation system 102 may suspend processing (e.g., allocation of the asset) until the electronic images are verified. Alternatively, the asset allocation system 102 may generate an image warning that is presented alongside the allocation of the asset to a class. In some examples, the image analysis system 118 may further compare electronic images submitted by the user system 122 to past electronic images that have been submitted to the asset allocation system 102. For example, the image analysis system may determine accidental duplication and/or possible malicious activity based on identifying a match between an electronic image in the set submitted by the user system 122 and a past set of electronic images that has been processed.

The prompt system 124 can prompt the vision language model 128 to generate output based on the electronic images. For example, the prompt system 124 can select prompts to provide to the vision language model 128 to determine whether there are any deficiencies in an electronic image. In some examples, the prompt system 124 may select prompts based on a label associated with an electronic image. For example, electronic images may be associated with labels indicating which station they are associated with. Additionally, or alternatively, the prompt system 124 may prompt the vision language model 128 to determine a station associated with an electronic image. Based on the output, the prompt system 124 can prompt the vision language model 128 to identify deficiencies associated with that station. In yet another example, the prompt system may provide a list of possible deficiencies to the vision language model 128 that could be present in a plurality of stations. In this example, the vision language model 128 can generate output identifying any electronic images that are associated with the possible deficiency and which deficiency has been identified in the electronic image. In an example, the prompt system 124 can generate prompts using an LLM. For example, the prompt system 124 may execute an LLM to generate a subsequent prompt based on output of the vision language model 128.

The vision language model 128 can identify deficiencies based on the electronic images. For example, the vision language model 128 can be an artificial intelligence model (e.g., segment anything model (SAM), contrastive Language-Image Pretraining (CLIP), Bootstrapping Language-Image Pretraining (BLIP), and/or the like) configured to generate a text output based on visual features within the electronic images. In this example, the vision language model 128 may be a pre-trained model that is fine-tuned using a training dataset that includes descriptions of deficiencies. The deficiencies may be described in accordance with impairment conditions included in HUD Handbook 4000.1. Based on the FHA-specific training dataset, the vision language model 128 may be trained to generate text descriptions of deficiencies in accordance with impediments included in FHA standards. In an example, the vision language model 128 may be an external model accessed via an API. The vision language model 128 can generate output based on the electronic images and prompts received from the prompt system 124. The output can be a text string response to the prompts. For an example, the output can indicate which predefined segment of the asset an electronic image represents, whether certain elements of the predefined segment (e.g., gutters) are present, and a quality of elements present in the electronic image. In an example, the vision language model 128 can generate two outputs based on identifying a deficiency in an electronic image. The first output can be an indication of an electronic image from which the vision language model 128 identified the deficiency. The second output can be a text description of the deficiency. As an example, in response to identifying charring in a fireplace, the vision language model 128 can generate the following output: “object: Fireplace; condition: charring”. In this example, the identified object can either be a station of the electronic image or an object that has been identified by the vision language model 128. In some examples, the vision language model 128 may be trained to provide more or less detailed output (e.g., “charring” versus “severe charring that has spread to the surrounding walls”).

The report system 126 may be associated with a large language model (LLM) configured to generate a text report based on output of the vision language model 128. In an example, the LLM may be a model that is external to the asset allocation system 102. In this example, the LLM may be accessed via an API. As an example of identifying a deficiency, the prompt system 124 may prompt the vision language model 128 to determine if any deficiencies of a set of deficiencies (e.g., missing shingles, damaged flashing, clogged gutters, and/or the like) are present in an electronic image of the roof. In this example, the vision language model 128 may return an indication of the electronic image and a text description of identified errors (e.g., “Station: Roof” and “Condition: Missing shingles”). Based on this indication, the report system 126 can generate a text description of deficiencies present in the electronic image (e.g., “Missing shingles on roof”). In an example, the report can display text descriptions of deficiencies alongside the associated electronic image that the deficiency was identified from to the user system 122 as part of a GUI.

The computer model 114 can determine an allocation of the asset. For example, the computer model 114 can determine a value associated with each class of a set of classes and then allocate the asset to the class with the highest value. The computer model 114 may be a statistical model that generates values (e.g., NPVs) of the classes based on input from the image analysis system 118 indicating deficiencies of the asset, asset data associated with the asset, and/or data retrieved from the partner systems 110. For example, based on the deficiencies indicated by the image analysis system 118, the asset allocation system 102 can determine a cost associated with resolving each deficiency. The computer model 114 may determine which deficiencies are associated with standards of which classes. For example, assets may be auctioned “as is,” and therefore the associated standards define that deficiencies are not resolved before the asset is auctioned. The computer model 114 may therefore not factor the cost of fixing any deficiencies into the value of auctioning the asset. As another example, FHA conveyance may indicate standards associated with resolving at least some of the deficiencies. In this example, the computer model 114 may factor the cost of resolving the deficiencies into the value (e.g., NPV) of FHA conveyance.

The GUI system 116 can generate a GUI through which the user system 122 and/or partner systems 110 can interact with the asset allocation system 102. For example, the GUI system 116 can generate a GUI that can be displayed on the user system 122. Users may submit requests to allocate an asset and/or manage tasks associated with classes via the GUI. The GUI can also display progress of tasks associated with classes. For example, the GUI can indicate which tasks have been completed, started, and/or have not been started. In this example, the GUI can indicate when a task is late according to the guidelines of a class. In some examples, the GUI can indicate the allocation of the asset generated by the computer model 114. For example, the GUI system 116 can generate a GUI displaying the class that the computer model 114 has calculated to have the highest value. Based on the user prevented in the GUI, a user of user system 122 can determine which class to allocate the asset to.

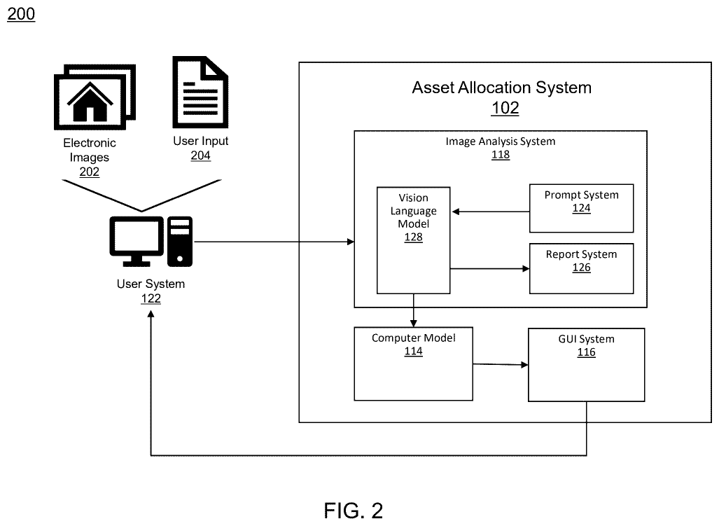

FIG. 2 illustrates a flow diagram of determining allocations of assets, according to an embodiment. In some examples, the flow diagram may represent a process 200 for determining an allocation of an asset to a class based on electronic images 202 and user input 204. The process 200 may be implemented by components including a user system 122 and an asset allocation system 102. The allocation system can include computer model 114, the GUI system 116, and the image analysis system 118. The image analysis system 118 can include the vision language model 128, prompt system 124, and report system 126. However, other embodiments may include additional or alternative elements (e.g., steps, components, inputs, and/or outputs) or may omit one or more elements. The illustrated process 200 can be used to determine an allocation of an asset associated with the electronic images 202 and the user input 204 to a class.

The user system 122 may transmit a data packet including the electronic images 202 and the user input 204 to the asset allocation system 102. The electronic images 202 may be electronic images of an asset. For example, the electronic images 202 may be electronic images of various stations of an asset. The stations may be predefined segments of the asset. As an example, the stations can be predefined segments of a property that can include common areas of properties such as the roof, fireplace, gutters, backyard, bathroom, and/or the like. Additionally, or alternatively, the user system 122 may transmit user input 204 associated with the asset. In an example where the asset is a property, the user input 204 can include numerical attributes of the property, such as an appraisal value, a cost of repairs already made to the property, a value of a foreclosed upon mortgage (e.g., unpaid principle balance), and/or the like. The user input 204 can also include details for calculating a value associated with each class, such as a time to sell by each class (e.g., FHA conveyance, auction, and/or the like), a selling price for each class, and/or the like. In an example, the asset allocation system 102 may generate a default value (e.g., a default auction price) based on the user input. For example, the asset allocation system 102 may determine a default auction selling price based on an appraisal price included in the user input 204. In this example, the user input 204 may include values that are used to calculate the value of classes instead of the default values (e.g., replace the default values). As such, the user input 204 may customize values used to determine the allocation of the asset.

Based on the electronic images 202 transmitted by the user system 122 the image analysis system 118 can identify one or more defects of the associated asset. For example, the image analysis system 118 can identify defects of the asset based on output generated by the vision language model 128. In an example, the image analysis system 118 can provide a first electronic image and a prompt to the vision language model 128. In some examples, the prompt may be a first prompt submitted based on a predefined segment of a first electronic image (e.g., included as a label of the first electronic image). In other examples, the prompt may be a list of possible defects at various segments the asset. For example, the vision language model 128 may be trained to identify which segment of a group of predefined segments that each electronic image in the electronic images 202 is associated with and generate output indicating when a defect is present. In some examples, the vision language model 128 can generate output indicating a subset of the electronic images. For example, based on ingesting the electronic images, the vision language model 128 can indicate which electronic images display deficiencies. Additionally, the vision language model 128 can generate a text output describing what the deficiency is. For example, for each electronic image in the subset of electronic images, the vision language model 128 can generate output including a text description of the deficiency. The output of the vision language model 128 can then be transmitted to the report system 126.

The report system 126 can generate a report based on the output generated by the vision language model 128. In an example, the report system 126 may provide the output of the vision language model 128 to an LLM to cause it to generate a text description of deficiencies that can be included as part of the report. In some examples, the report may identify a set of deficiencies associated with the asset. The deficiencies may indicate issues with the asset that put it out of compliance with at least one of the classes (e.g., impediments). In an example, the report may be a list of the deficiencies. For example, the list may simply indicate segments of the asset that include deficiencies or give more detail on the severity of the deficiencies. As an example, missing shingles can be indicated to be minor damage while a sagging roof may be considered major damage. In some examples, the report may be presented to the user system 122.

In some examples, the asset allocation system 102 may aggregate the report generated by the image analysis system 118 with the user input 204 to generate evaluation data. The evaluation data may represent a data set based on which the computer model 114 can evaluate the asset. In an example, generating the evaluation data can include evaluating a cost and/or timeline for the deficiencies associated with the asset. In this example, the asset allocation system 102 may interact with one or more partner system (e.g., such as partner systems 110 of FIG. 1) to determine a cost and/or timeline of fixing a deficiency. As an example, the asset allocation system 102 can submit an API call to a partner system requesting a current cost of replacing shingles of a property. The asset allocation system 102 may also determine a timelier associated with repairs. The timeline may be relevant to determining values of classes, as it may affect a cost of the repair if it increases the time until the property is sold or conveyed (e.g., due to holding costs such as property tax, insurance, and/or the like). In some examples, the asset allocation system 102 may generate a numerical score as part of the evaluation data. In an example where the asset is a property, the asset allocation system 102 may generate a numerical score representing the condition of the property based on predefined criteria set by the Department of Housing and Urban Development (HUD). In this example, the predefined criteria may be associated with requirements to be allocated to a class (e.g., conveyance condition requirements).

The computer model 114 can then generate a value associated with each class based on the evaluation data. The computer model 114 may be a statistical model configured to generate an output value for each class based on input values indicated in the evaluation data. For example, the computer model 114 can generate a NPV of each class based on data associated with the house included in the user input 204 and the cost and timeline to repair deficiencies indicated by the report. As an example, the classes may include selling the property at auction, FHA conveyance, and direct sale. The computer model 114 can generate a NPV of each class based at least on the selling price at each class and the deficiencies that would be fixed to make the property eligible for the class. For example, selling at auction may result in a lower selling price than FHA conveyance. However, the deficiencies that would be fixed to make the property eligible for FHA conveyance may be greater than the difference in selling price. As an example, the timeline (e.g., and therefore holding costs) along with the cost of repairs associated with repairing deficiencies for FHA conveyance may outweigh the difference in selling prices. The computer model 114 may also factor in further calculations, such as debenture interest claims (e.g., interest from date of default to date of conveyance), non-claimable expenses (e.g., routine maintenance), timeline associated administrative processing, and/or the like for each class. In some examples, the asset allocation system 102 may allocate the asset to a class based on the values generated by the computer model 114. For example, the asset allocation system 102 may allocate the asset to the class with the highest value.

The GUI system 116 may generate a GUI indicating the allocation of the asset to a class. For example, the GUI system 116 may generate a GUI indicating the values associated with the classes and the class that the asset allocation system 102 has allocated the asset to. In some examples, the GUI can also include a set of tasks. The tasks can be associated with the deficiencies of the asset. Additionally, or alternatively, the set of tasks can be associated with a class. For example, tasks may specify deadlines for addressing deficiencies that hinder the asset's compliance with class standards. As an example, the set of tasks can be associated with FHA conveyance. The set of tasks can indicate deadline dates of resolving deficiencies and/or performing tasks associated with standards of FHA compliance.

The GUI generated by the GUI system 116 may be transmitted back to the user system 122. For example, a GUI indicating an allocation of the asset to a class along with the calculated value of each class can be presented to the user system 122. The GUI may provide information the user of the user system 122 that can be used to determine a course of action. For example, the user can decide to allocate the asset to a class based on the allocation determined by the system. Alternatively, the user may select another class. For example, the user may determine that the difference in value is insignificant (e.g., in light of extra uncertainty, work on the part of the user, and/or the like associated with the class the asset allocation system 102 has allocated the asset to). In some examples, the asset allocation system may be reconfigured based on which class the user selects to allocate the asset to. For example, in response to the user selecting a class that is not the same class that is determined by the system, one or more thresholds may be reconfigured. In this example, one or more thresholds within the computer model 114 may be reconfigured. Alternatively, one or more thresholds that determine the allocation of the asset to the class within the asset allocation system 102 may be reconfigured. For example, the asset allocation system 102 can be configured to present a recommendation that is not the class with the highest value generated by the computer model 114 based on previous user selections. In an example, the asset allocation system 102 may generate probability-weighted disposition scores. The scores may be generated based on past selections of the user. In an example where more than one class is associated with a positive value, the asset allocation system 102 may allocate the asset to the class with the highest disposition score, instead of the class with the highest value generated by the computer model 114.

In some examples, the user system 122 may transmit API calls to partner systems via the GUI. For example, the user system 122 may determine that the asset will be allocated to a class (e.g., based on the allocation determined in the asset allocation system 102). In this example, the user system 122 may submit an API call associated with a task of the class. For example, the user system 122 may trigger a workflow to the API of a partner system associated with a task of the class. This can allow the task to be setup as an action item in the partner system. As another example, the user system 122 can submit an API call requesting a status update on a task.

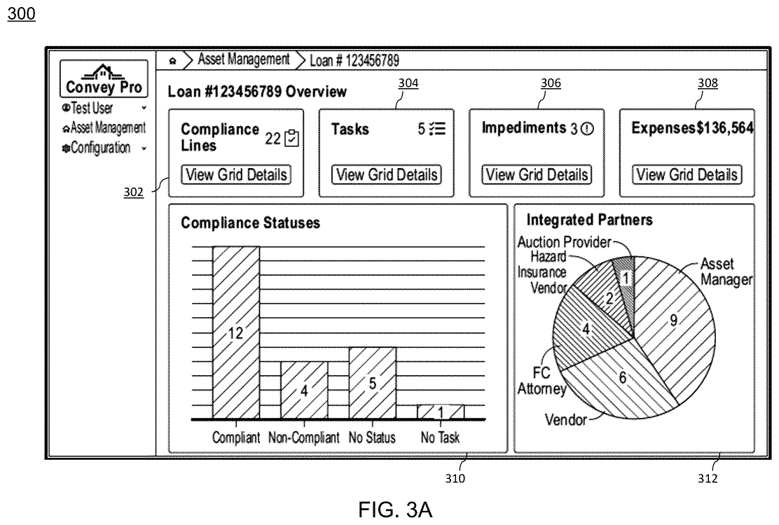

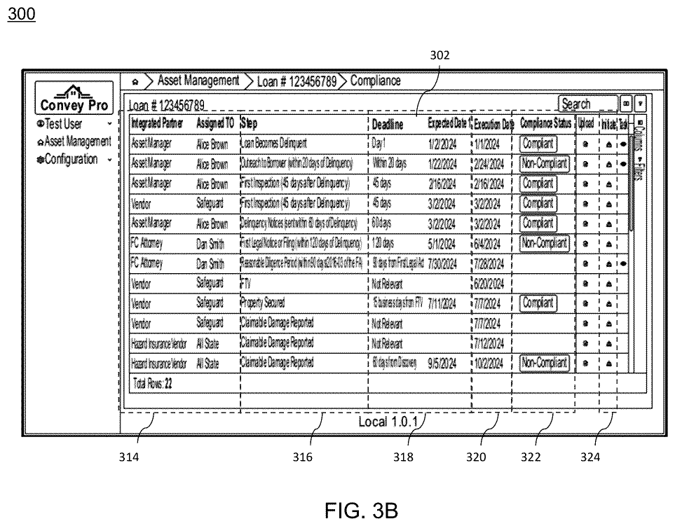

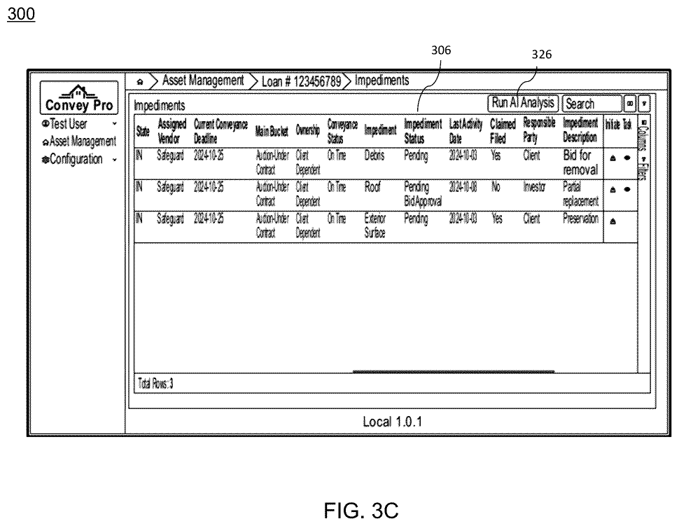

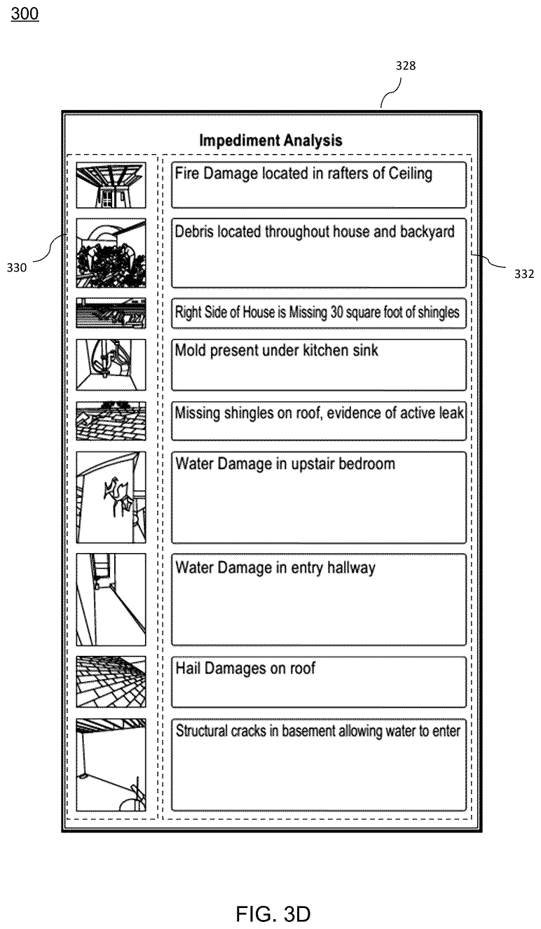

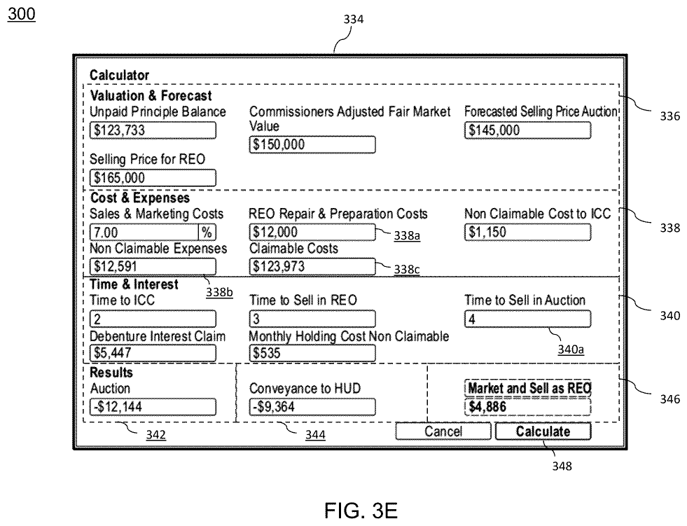

FIGS. 3A-3E show illustrative diagrams of graphical user interfaces 300 that may be displayed in connection with allocation of an asset, according to an embodiment. For example, graphical user interfaces 300 can be displayed on a user system (e.g., such as the user system 122 of FIG. 1) as part of the request to allocate the asset to a class and/or interact with partner systems (e.g., such as partner systems 110 of FIG. 1) associated with the classes. In this example, the graphical user interfaces 300 may display information generated by an asset allocation system (e.g., such as the asset allocation system 102 of FIG. 1). In the illustrated examples, the asset may be a property that has been foreclosed upon, and the asset allocation system may present an allocation of the asset to a class (e.g., auction, FHA conveyance, sell as REO asset) and/or tasks associated with the class.

Referring now to FIG. 3A, a graphical user interface 300 associated with an asset can be displayed on a user system. The asset may be a property associated with a loan that has been foreclosed upon (e.g., “Loan #123456789”). The graphical user interface 300 can include selectable icons that a user of the user system 122 may select to view more information, including compliance lines display 302 tasks display 304, impediments display 306, and expenses display 308. Once selected, the compliance lines display 302 may display tasks associated with compliance lines of a class. For example, compliance lines display 302 can display a set of tasks associated with compliance of class standards. For example, the compliance lines display 302 can display a set of tasks associated with compliance with the class standards of FHA conveyance. The tasks display 304 can display a set of open tasks. The open tasks may be associated with tasks from the compliance lines display 302 and/or the impediments display 306. Tasks may be determined to be open tasks based on indications transmitted by the user system. For example, a task can be determined to be open based on the user system transmitting an indication that it should be open, the user system transmitting a request for information from a partner system in association in with the task, and/or the like. In an example, a task may be removed from the tasks display 304 based on the task being resolved (e.g., completed). In this example, the user system and/or a partner system can indicate that the task has been resolved. The impediments display 306 can display a set of tasks associated with deficiencies of the asset. The deficiencies can also be determined based on the standards of a class. As an example, based on the identified deficiencies and the standards of for FHA conveyance, the asset allocation system can determine that there are 3 deficiencies that should be resolved for compliance with standards for FHA conveyance (e.g., there are three impediments). The impediments display 306 can display tasks associated with these deficiencies along with relevant information about the status of the tasks. The expenses display 308 can include an indication of the expenses that have been incurred with the property. These expenses can include maintenance, repairs, property taxes, insurance, utilities, administrative costs, and/or the like. The expenses value indicated by the expenses display 308 (e.g., “$136,564”) may be used by the asset allocation system to determine a value of each class. In some examples value can include both claimable expenses (e.g., reimbursable if the property is conveyed to HUD via the FHA conveyance program) and non-claimable expenses (e.g., not reimbursable).

The graphical user interface 300 can also include a set of graphs including compliance statuses graph 310 and integrated partners graph 312. These graphs can provide a visual representation of tasks associated with the asset and/or partner systems associated with the tasks. The compliance statuses graph 310 can display a visual representation of tasks included in the compliance lines display 302. For example, the compliance statuses graph 310 can depict an indication of which tasks are compliant, and which are non-compliant. A task may be determined to be compliant based on whether it has been executed before an associated deadline. Some tasks may not have a status. For example, some tasks may not be associated with a deadline and therefore may not be associated with a status indicating whether the task has been completed by the deadline. As an example, reporting certain expenses may not be associated with a deadline determined as a time period from default of the loan. While reporting the expenses may be associated with a deadline, such as reporting before FHA conveyance, lack of reporting may not make the property ineligible for FHA conveyance. Therefore, this task may not have a compliance label. Some tasks may not have an action and therefore may be labelled “No Task”. For example, the compliance lines display 302 may include an indicator of a deadline that does not have an action item (e.g., task) associated with it.

The integrated partners graph 312 may display a visual representation of which partner system is associated with the tasks of the compliance lines display 302. The partner systems may be responsible for performing actions associated with tasks. As an example, a foreclosure attorney (e.g., “FC Attorney”) may be responsible for filing a legal notice of delinquency within a certain time period of default on loans. As depicted in the graphical user interface 300, the integrated partners graph 312 and the compliance statuses graph 310 are a pie chart and a bar graph, respectively. However, the compliance statuses graph 310 may be any graphical representation of the status of tasks associated with the compliance lines display 302. Likewise, the integrated partners graph 312 may be any graphical representation of the partner systems that are responsible for tasks.

Referring now to FIG. 3B, a graphical user interface 300 including the compliance lines display 302 can be displayed on the user system. For example, the graphical user interface 300 may be displayed in response to the user selecting an icon displayed as part of the graphical user interface 300 on the user system associated with the compliance lines display 302. Each row of the compliance lines displays 302 can be associated with a task for compliance with a class. For example, the set of tasks can be associated with standards of a class (e.g., FHA conveyance). The steps column 316 can indicate a short description of each task. Each task can be associated with a partner system, indicated in the integrated partner column 314, that is responsible for the performing the step (e.g., at least part of the step). The integrated partner column 314 can identify a partner system that is responsible for at least part of a task. For example, a partner system may review and approve insurance claims, file paperwork for the foreclosure process, perform repairs, and/or the like as part of a task. In an example, the integrated partner column 314 can identify a category of partner system and a specific entity. As an example, foreclosure attorney (e.g., “FC attorney”) can be identified as a category of partner system, and a specific attorney (e.g., “Dan Smith”) can be identified is the specific entity assigned to the task. In this example, the specific entity can be the entity that can be contacted via the initiate task icons 324. Through the initiate task icons 324, the user system can transmit messages to partner systems associated with tasks. For example, in response to receiving a selection of an initiate icon from the initiate task icons 324, the asset allocation system can present an initiate task pop-up, where a user may fill in details associated with a request to initiate the task. The request can then be transmitted to the associated partner system. In some examples, transmitting a message to a partner system via an initiate task icon can mark the task associated with the task as open. As a result, the task may appear as part of a tasks display (e.g., such as tasks display 304 of FIG. 3A). Some of the tasks may be associated with deadlines from the deadline column 318. The deadline column 318 may display both a date from default (e.g., “Loan Becomes Delinquent”) indicating a number of days from the default date of the loan and an expected date indicating an actual date of the deadline (e.g., based on the date of default). The execution column 320 can include an indication of when tasks were completed. For example, the execution column 320 can include an execution date for the various tasks. In an example, the execution column 320 may be filled out with dates as tasks for a class (e.g., FHA conveyance) are completed. The compliance status column 322 may indicate whether a task is in compliance with the deadline indicated in the deadline column 318. Tasks may be marked “Compliant” or “Non-Compliant” based on whether the associated execution date in the execution column 320 is on or before the deadline in the deadline column 318. Some tasks may not be associated with a deadline (e.g., the deadline may be marked as “Not Relevant”). As a result, these tasks may also not be associated with a compliance status.

Referring now to FIG. 3C, a graphical user interface 300 including the impediments display 306 can be displayed on the user system. For example, the graphical user interface 300 may be displayed in response to the user selecting an icon associated with the impediments display 306 displayed as part of the graphical user interface 300 on the user system. The impediments can be based on a set of deficiencies (e.g., a set of deficiencies determined by the image analysis system 118 of FIG. 1). For example, the user system can transmit a set of electronic images to the asset allocation system. In an example, the user system can transmit a selection of AI analysis button 326. Based on the set of electronic images and the indication, the asset allocation system may generate a vision language model. The vision language model can generate output, such as the output displayed in FIG. 3D. In an example, the output of the vision language model can be summarized by a report system (e.g., such as the report system 126 of FIG. 1). In some examples, the report system can generate a set of impediments based on the deficiencies indicated by the output of the vision language model. The impediments can identify aspects of the asset that should be repaired to make the asset eligible for a class (e.g., FHA conveyance).

Referring now to FIG. 3D, a graphical user interface 300 including an impediment analysis 328 can be displayed on the user system. The impediment analysis 328 can include a subset of electronic images 330 associated with deficiencies of the asset and a set of attributes 332 associated with output of the vision language model. In an example, the impediment analysis 328 can be a report compiled by the report system. In some examples, the set of attributes 332 may be output of the vision language model. For example, a prompt system within the image analysis system can be configured to provide prompts asking about specific issues that an asset could have. Examples of prompts that can ask about possible deficiencies in a roof can include “Are any shingles curling?” “Is the flashing of the chimney intact?” “Does the chimney have a crown?”. Based on the prompts and the set of electronic images, the vision language model can generate attributes 332 indicating whether any of the issues have been found. In an example, the vision language model can be trained to generate (e.g., phrase) attributes according to a list of interstate commerce commission (ICC) impediments. In some examples, the report system can generate the set of attributes 332 based on the output of the vision language model. For example, the report system can provide the output to an LLM to cause the LLM to generate the attributes 332. In this example, the LLM may generate an attribute for each electronic image (e.g., or each station) based on modifying an output and/or summarizing multiple outputs. As an example, the vision language model can generate outputs including “object: roof, condition: missing shingles” and object: roof, condition: active leak,” and the LLM can generate “Missing shingles on roof, evidence of active leak” based on these outputs.

Referring now to FIG. 3E, a graphical user interface 300 including a value calculator 334 can be displayed on the user system. The value calculator 334 can be used to determine the value (e.g., NPV) of allocation of an asset (e.g., a property) to different classes (e.g., auction, FHA conveyance, and REO sale). The value calculator 334 can include valuation & forecast input 336, cost & expenses input 338, and time & interest input 340. Based on these inputs, the asset allocation system can generate values for classes including an auction value 342 conveyance to HUD value 344, and a market and sell as REO value 346. In an example, the asset allocation system may calculate the values for the classes based on receiving a selection (e.g., from the user system) of calculate button 348. In some examples, the input values may include default values. For example, the time to sell for the three classes in the time & interest input 340 can be default values. Default values may be automatically initialized for all properties. In this example, the default values may be modified by the user system. For example, the user system may reduce auction sale time input 340a from 4 months to 3 months and transmit a selection of the calculate button 348 to recalculate values for the three class based on the new auction sale time input 340a Additionally, or alternatively, the input values may be determined based on user input (e.g., transmitted from the user system). For example, the user input can include a set of expenses that indicates which expenses are claimable and non-claimable. In this example, non-claimable expenses input 338b and claimable costs input 338c can be generated based on the set of expenses submitted as part of the user input.

In some examples, at least one input value may be based on the set of deficiencies identified by the vision language model. For example, the asset allocation system can determine a cost associated with each deficiency and may identify a repairs cost for each class based on which deficiencies would be repaired to bring the property up to standards for the class. As an example, REO costs input 338a may represent costs to resolve deficiencies to fit standards of selling a property as an REO asset. As another example, non-claimable expenses input 338b and claimable costs input 338c can represent the costs to resolve deficiencies to fit standards of FHA conveyance to HUD. In this example, the claimable costs input 338c may be reimbursed by HUD, while the non-claimable expenses input 338b may not. In an example, there may be no repair costs for auctioning the property. For example, the property may be auctioned as is. In some examples, holding costs for each class may be generated based on the time & interest input 340. For example, based on the predicted times to sell for the three classes in time & interest input 340 and the indicated monthly holding cost, the asset allocation system may determine a holding of the class.

The asset allocation system may allocate the property to a class based on comparing the auction value 342 conveyance to HUD value 344, and the market and sell as REO value 346. For example, based on identifying the class with the highest value (e.g., REO value 346, in the illustrated example), the asset allocation system may identify the class as the recommended class. This determination can be presented to the user system as part of the graphical user interface 300 to inform future decisions about the property.

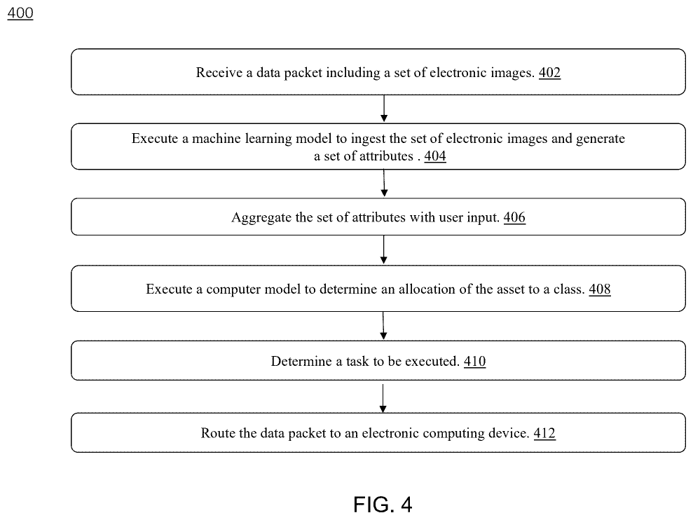

FIG. 4 illustrates a flow process for determining allocations of assets, according to an embodiment. The method 400 may include steps 402-408. However, other embodiments may include additional or alternative steps or may omit one or more steps altogether. The method 400 is described as being executed by an asset allocation system (e.g., a computer similar to the asset allocation system 102). However, one or more steps of the method 400 may be executed by any number of computing devices operating in the system described in FIG. 1.

At step 402, the asset allocation system may receive data packet including a set of electronic images. The data packet may be a unit of data transmitted over a network (e.g., network 120 of FIG. 1). The data packet can include a set of files that represent the electronic images as the payload. The electronic images may be associated with an asset. Electronic images may be digital images captured using a digital camera. In some examples, the set of electronic images may be taken at predefined segments of the asset. For example, the set of electronic images may include images of predefined segments of an asset that the asset allocation system is configured to evaluate. As an example, the asset may be a property, and the predefined segments may be portions of the property (e.g., the fireplace, the roof, the backyard, and/or the like). Additionally, or alternatively, the payload can include user input associated with the asset. For example, the payload can include data that describes the asset (e.g., a market value of the asset, an unpaid principal balance of a loan associated with the asset, and/or the like).

At step 404, the asset allocation system may execute a machine learning model to ingest the set of electronic images. The machine learning model may be a vision language model configured to generate output based on input electronic images and/or prompts. The machine learning model may be trained to generate output identifying deficiencies of an asset displayed in the electronic images. In an example, the machine learning model may determine a segment associated with an electronic image based on a label included with the electronic image. In another example, the machine learning model can determine the segment based on receiving a prompt (e.g., from a prompt system of the asset allocation system). In yet another example, the machine learning model may be trained to recognize which segment an electronic image is associated with in response to receiving the electronic image, and to generate output to a prompt including based in part on this determination. After identifying a segment of the asset, the machine learning model can generate attributes based on prompts and the electronic images. In some examples, the prompts can ask the machine learning model to identify if a defect is present in an electronic image. As an example, the machine learning model can receive a set of prompts asking if a set of deficiencies are present in any of the electronic images. Alternatively, the machine learning model may sequentially receive prompts for each electronic image (e.g., based on the associated segment). Based on the prompts, the machine learning model can generate attributes of the electronic images. Each attribute of an electronic image can indicate a quality of the asset's segment depicted in the image by indicating if there are any deficiencies present. For example, the attribute can indicate, that a defect is present in an electronic image (e.g., “water damage in entry hallway”). Alternatively, the attribute can indicate that no defect has been identified for an electronic image. In this example, the electronic image may not be associated with an attribute (e.g., no output provided). In some examples, the machine learning model may determine whether an electronic image is associated with a subset of the electronic images (e.g., such as the subset of electronic images 330 of FIG. 3D) based on the associated attribute generated by the machine learning model. The subset of electronic images may be electronic images that indicate deficiencies in the asset. In an example, electronic images may be determined to belong to the subset based on being associated with an attribute that indicates at least one.

In some embodiments, the attribute may be a text string indicating a deficiency of the asset associated with the electronic image (e.g., like attributes in the set of attributes 332 of FIG. 3D). For example, the machine learning model may be a vision language model configured to generate text output (e.g., attributes) answering questions about an electronic image based on provided prompts.

In some examples, the attribute may be generated by an LLM based on output of the machine learning model. For example, the machine learning model can generate one or more outputs for an electronic image indicating that there is at least one deficiency present. In an example, the asset allocation system may provide the output to an LLM to cause it to generate the attribute. In this example, the LLM may be an external model to the asset allocation system. As an example, based on output including “object: fireplace, condition: charring”) the LLM can generate the attribute “severe charring around the fireplace.”

In some embodiments, the machine learning model may be a vision model that is trained on labeled datasets of deficiency conditions. For example, the vision model may be a pre-trained model that is fine-tuned on datasets that are specific to FHA conveyance. As an example, the training dataset can include electronic images and corresponding deficiency descriptions that are written in accordance with impairment conditions included in HUD Handbook 4000.1. Based on the training dataset, the machine learning model can be trained to generate attributes that include language which indicates certain impairment conditions that put a property out of compliance with standards for FHA conveyance.

At step 406, the asset allocation system may aggregate the set of attributes with user input. For example, the asset allocation system may receive user input associated with the asset (e.g., in addition to the set of electronic images). The user input can include numerical values associated with the asset. As an example, the user input can include (e.g., such as one or more of the input values included in valuation & forecast input 336, cost & expenses input 338, time & interest values of FIG. 3E). In some examples, the asset allocation system may aggregate the set of attributes associated with the electronic images and indication of the subset of electronic images (e.g., indication of deficiencies) with the user input to generate evaluation data. In an example, generating the evaluation data may include evaluating the cost to resolve deficiencies indicated by the output of the machine learning model. In this example, the timeline of resolving deficiencies may also be determined. Cost and timeline information may be determined based on submitting API calls to a partner system. This interaction with the partner system may be defined by an SLA.

At step 408, the asset allocation system may execute a computer model to determine an allocation of the asset to a class. For example, the computer model may be a statistical model that can determine a value associated with each class of a set of classes. The computer model may generate this determination based on the evaluation data. For example, based on input values (e.g., such as input values 336-340 of FIG. 3E) included in the evaluation data, the computer model may generate a value for each class. In this example, each class may be associated with a set of standards. Standards may outline which deficiencies should be resolved for a property to eligible for the class. Based on these standards, the computer model may determine which classes incur the cost of resolving which deficiencies. As an example, a property being sold at auction may be sold as-is and therefore may not incur any costs of resolving deficiencies. However, a property being conveyed to HUD may incur costs of complying with standards for FHA conveyance set forth by HUD. Based on the values generated by the computer model, the asset allocation system may determine an allocation value of each class (e.g., auction value 342 conveyance to HUD value 344, and market and sell as REO value 346 of FIG. 3E). The asset allocation system may then allocate the asset to the class associated with the highest allocation value.

In some embodiments, the asset allocation system may transmit a GUI including the allocation of the asset to the user device to be displayed. For example, a GUI may be generated displaying the allocation of the asset to the class in response to the asset being allocated to the class. This GUI may then be displayed on the user device. In some examples, the GUI may display the allocation value generated by the computer model for each class.

In some embodiments, the asset allocation system may update classification thresholds associated with allocating the asset based on input received from the user device. For example, in response to the GUI displaying the class that the asset allocation system has allocated the asset to, the user device may transmit user input changes the allocation of the asset to another class. In response to receiving the user input that changes the allocation of the asset, the asset allocation system may update a classification threshold. As an example, the asset allocation system may update one or more classification thresholds of the statistical model. In an example, the asset allocation system may determine the allocation of the asset based on a weighted score assigned to each class. The weighted score may give more weight to positive values for different classes. As an example, the weighted score may give more weight to a positive value determined for selling a property as an REO asset than the same positive value for FHA conveyance to HUD. As a result, the asset allocation system may allocate the property to sale as an REO asset, even if a higher value is generated by the computer model for FHA conveyance to HUD. In some examples, updating the classification thresholds can include updating the weights of these weighted scores. In these examples, the asset may be allocated based on user preference associated with classes, in addition to a respective value generated for each class by the computer model.

At step 410, the asset allocation system may determine a task to be executed based on the allocation. For example, each class may be associated with a set of tasks (e.g., rows of the compliance lines display 302 of FIG. 3B). The sets of tasks can indicate actions associated with allocating the asset to the class. As an example, different tasks may be performed for selling a property as an REO asset versus conveying the property to HUD. In some examples, the tasks can be determined, at least in part, based on the deficiencies identified from the set of electronic images. As an example, based on the deficiencies determined by the machine learning model (e.g., impediments of the impediments display 306 of FIG. 3C) and the asset being allocated to a class associated with standards that include resolving deficiencies (e.g., conveyance), the asset allocation system may identify resolving a deficiency as a task to be executed. In an example, the sets of tasks may be presented to the user device (e.g., via the GUI). In this example, the asset allocation system can determine the task to be executed based on user selection of a task. In some examples, each task can be associated with an electronic computing device (e.g., partner system). In these examples, the task can be routed to the computing device based on the determination that the task is to be executed. Additionally, or alternatively, tasks may be determined automatically based on the allocation of the asset to the class. For example, the asset allocation system may automatically determine tasks to be executed based on the class that the asset has been allocated to within the asset allocation system or an allocation of the asset to a class transmitted by the user device. As an example, the asset allocation system may determine the tasks to be executed based on confirmation of the allocation determined by the asset allocation system or a new allocation submitted by the user device.

At step 412 the asset allocation system may route the data packet to the electronic computing device associated with the task. For example, the asset allocation system may transmit at least part of the data packet to an electronic computing device associated with the determined task. As an example, the asset allocation system may transmit the electronic images and/or the user input to the computing device. Additionally, or alternatively, the asset allocation system may transmit data generated based on the data packet. For example, the asset allocation system may transmit the set of deficiencies determined based on the electronic images. In an example, the tasks can be associated with a set of electronic computing devices. In this example, the data packet may be routed to the electronic computing device associated with the determined task. In some examples, electronic computing devices may be associated with different data formats (e.g., HyperText Markup Language (HTML), Comma-Separated Values (CSV), and/or the like). In these examples, the asset allocation system may adapt the data packet to match a format associated with the computing device. In some examples, the electronic devices may be associated with different routing methods. For example, electronic computing devices may be associated with API interfaces, message queues, email communication, and/or the like. In these examples, the allocation system may adapt the data packet to a routing method before routing. For example, the asset allocation system can generate an API call including the data packet based on the electronic computing device being associated with an API routing method. As another example, the allocation system can generate an email including the data packet based on the electronic computing device being associated with an email routing method. In these examples, the asset allocation system may route the data packet by transmitting it via the routing method (e.g., API call, email, message, and/or the like).

In some embodiments, routing the task can trigger a workflow at the electronic computing device. For example, the asset allocation system can identify an API endpoint associated with the electronic computing device. The asset allocation system may transmit an API call including the data packet to the API endpoint. The API call may include part or all of the data packet. In an example, the API call can trigger a workflow including a series of predefined actions associated with the task. As an example, an API call to an electronic computing device associated with an insurance vendor may trigger a workflow for filing damage claims. The workflow can include a set of predefined actions associated with the damage claim, such as documentation collection, claim evaluation, claim payout determination, and/or the like. In an example, the workflow items can be associated with deadlines, which can facilitate timely completion of tasks associated with workflows.

In some embodiments, the user device may request a status update on the task. For example, the asset allocation system can receive a selection of the task. In an example, the asset allocation system may trigger workflows to multiple electronic computing devices as part of a set of tasks associated with the class. In this example, the user device may select one of the tasks as part of a request for a status update. Based on the request, the asset allocation system may access the associated electronic computing device by submitting an API call to an API associated with the electronic computing device. The API call may include a request for a status update on the task. In response to the API call, the asset allocation system can receive an API response that includes a status update. For example, the API response can update the status of the task within the analytic system to show that at least part of the task has been completed. In some examples, status updates may be sent automatically based on a deadline associated with the task.

In a non-limiting example of the described systems and methods, the asset allocation system can receive a data packet associated with a property that has been foreclosed upon. The data packet can include electronic images that captures various portions of a property. For example, the electronic images may capture the yard, kitchen, roof, fireplace, and/or the like. The data packet can also include data associated with the property. For example, the data packet can include an identifier for the property (e.g., address, mortgage identifier, and/or the like), remaining balance of the mortgage at the time of foreclosure, an appraisal value of the property, and/or the like. In an example, the asset allocation system may receive the data packet through a graphical user interface displayed on the user device and may modify displayed information on the graphical user interface (e.g., graphical user interface 300 of FIGS. 3A-3E) based on the data packet.

The asset allocation system may execute a machine learning model to identify deficiencies of the property. For example, the machine learning model may be a vision language model that can identify impediments of the property that make it ineligible for a disposition channel (e.g., FHA conveyance). In an example, the asset allocation system can provide a set of prompts to the vision language model that ask the vision language model to identify possible deficiencies (e.g., aspects of the property that would be repaired, cleaned, replaced, and/or the like to make it eligible for the disposition channel). In an example the electronic images can be associated with predefined stations within the property. As an example, a first station may be the fireplace, and a second station may be the roof. In this example, the machine learning model may generate output describing deficiencies that are present based in part on the station of the property associated with the electronic image. The output of the machine learning model may include text string descriptions of the deficiencies present in the asset. For example, in response to determining that a deficiency asked about in the set of prompts is present in an electronic image, the machine learning model can generate output including an indication of the electronic image and a text string description of the deficiency that is present. In some examples, the asset allocation system may generate a list of deficiencies based on the output of the machine learning model. These deficiencies may identify a set of impediments that make the property ineligible for a disposition channel. The asset allocation system may display a subset of the electronic images that are associated with the deficiencies (e.g., the subset of electronic images 330 of FIG. 3D) and corresponding descriptions (e.g., the set of attributes 332 of FIG. 3D) of the deficiencies that may be the output of the machine learning model or generated based on the output of the machine learning model on the graphical user interface of the user device.

In some embodiments, the asset allocation system may determine an allocation of the property to a disposition channel based on the data associated with the property included in the data packet and/or the deficiencies determined by the machine learning model. For example, the asset allocation system can execute a statistical model to determine a value (e.g., net present value) for each disposition channel that takes into account costs of repairs (e.g., cost & expenses input 338 of FIG. 3E), a time frame for the sale (e.g., time & interest input 340 of FIG. 3E, and a predicted selling price for that disposition channel (e.g., valuation & forecast input 336 of FIG. 3E). Factors such as selling price and cost of repairs may differ between disposition channels. For example, FHA conveyance may be associated with a higher cost of repairs due to stricter standards for eligibility of a property for this disposition channel. In an example, the asset allocation system may determine a cost of repairs based on deficiencies identified by the machine learning model. For example, the asset allocation system may interact with partner systems to determine a cost of repairing certain deficiencies. This cost can be factored into the value of a class. In some examples, the asset allocation system may determine a recommended allocation of the asset to a disposition channel based on the values. For example, the asset allocation system may present a recommendation of the disposition channel with the highest value on an interface of the user device along with an indication of the value associated with each disposition channel (e.g., value calculator 334 of FIG. 3E). In an example, the property may be allocated to the recommended disposition channel. Alternatively, the property may be allocated to a different disposition channel based on a selection received from the user device.

In some embodiments, the asset allocation system may identify tasks associated with the disposition channel and route at least part of the data packet to partner systems associated with these tasks. For example, each disposition channel may be associated with a set of tasks (e.g., rows of compliance lines display 302 of FIG. 3B). The tasks may be associated with external partner systems that perform at least part of the task (e.g., partner systems displayed in integrated partners graph 312 of FIG. 3A). As an example, FHA conveyance may be associated with tasks such as inspections and legal notices. In an example, some of the tasks may be repairs associated with the deficiencies identified by the machine learning model (e.g., rows of impediments display 306 of FIG. 3C). In some examples, the asset allocation system may identify at least one task associated with the disposition channel that the asset has been allocated to and route at least part of the data packet to a partner system that is responsible for the task. For example, a partner system may handle repairs. The analytics sever can identify the partner system associated with repairing a type of deficiency identified as present in the property and route the electronic image indicating the deficiency and data about the property to the partner system. In an example, the asset allocation system can trigger a workflow that includes a set of predefined steps for resolving the deficiency at the partner system. Overall, described systems and methods may facilitate evaluation of properties and management of tasks involving partner systems. The asset allocation system may therefore represent an improved system for managing allocation of properties to disposition channels.

Having now described some illustrative implementations, the foregoing is illustrative and not limiting, having been presented by way of example. In particular, although many of the examples presented herein involve specific combinations of method acts or system elements, those acts, and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Scope of the systems and methods described herein is thus indicated by the appended claims, rather than the foregoing description. The scope of the claims includes equivalents to the meaning and scope of the appended claims.

What we claim is:

1. A method comprising:
receiving, by at least one processor, a data packet comprising a set of electronic images associated with an asset;
executing, by the at least one processor, a machine learning model to ingest the set of electronic images and generate a set of attributes, wherein the machine learning model is configured to, for each electronic image in the set of electronic images:
identify a segment of the asset associated with the electronic image;
generate, based on the electronic image, an attribute comprising a description of quality of the segment of the asset; and
determine, based on the attribute, whether the electronic image is associated a subset of the electronic images;
aggregating the set of attributes and an indication of the subset with user input about the asset to generate evaluation data;
executing a computer model to determine an allocation of the asset to a class of a set of classes based on the evaluation data;
determining, by the at least one processor, based on the class, a task of the class to be executed; and
routing, by the at least one processor, the task and the data packet to an electronic computing device associated with the task.

2. The method of claim 1, wherein generating the attribute further comprises:
generating, based on the electronic image, an output; and
providing the output to a large language model to cause the large language model to generate the attribute.

3. The method of claim 1, wherein the attribute comprises a text string indicating a deficiency of the asset associated with the electronic image.

4. The method of claim 1, wherein routing the task further comprises:
identifying an application programming interface (API) endpoint of an API that associated with the electronic computing device; and
transmitting an API call including the data packet that triggers a series of predefined actions associated with the task at the electronic computing device.

5. The method of claim 1, wherein the method further comprises:
receiving a selection of the task associated with the electronic computing device;
accessing the electronic computing device via an API call to an API of the electronic computing device; and
receiving an API response to the API call comprising a status representing a completion progress of the task.

6. The method of claim 1, wherein the method further comprises:
generating a graphical user interface (GUI) displaying the allocation of the asset to the class; and
displaying the GUI on a user device.

7. The method of claim 6, wherein the GUI comprises an allocation value, generated by the computer model based on the evaluation data, associated with each class of the set of classes.

8. A computer system comprising a computer-readable medium storage comprising a set of non-transitory instructions, that when executed, cause a processor to:
receive a data packet comprising a set of electronic images associated with an asset;
execute a machine learning model to ingest the set of electronic images and generate a set of attributes, wherein the machine learning model is configured to, for each electronic image in the set of electronic images:
identify a segment of the asset associated with the electronic image;
generate, based on the electronic image, an attribute comprising a description of quality of the segment of the asset; and
determine, based on the attribute, whether the electronic image is associated a subset of the electronic images;
aggregate the set of attributes and an indication of the subset with user input about the asset to generate evaluation data;
execute a computer model to determine an allocation of the asset to a class of a set of classes based on the evaluation data;
determine, based on the class, a task to be executed; and
route the task and the data packet to an electronic computing device associated with the task.

9. The computer system of claim 8, wherein the set of non-transitory instructions that cause the processor to generate the attribute further cause the processor to:
generate, by the machine learning model based on the electronic image, an output; and
provide the output to a large language model to cause the large language model to generate the attribute.

10. The computer system of claim 8, wherein the attribute comprises a text string indicating a deficiency of the asset associated with the electronic image.

11. The computer system of claim 8, wherein the set of non-transitory instructions that cause the processor to route the task further cause the processor to:
identify an application programming interface (API) endpoint of an API that associated with the electronic computing device; and
transmit an API call including the data packet that triggers a series of predefined actions associated with the task at the electronic computing device.

12. The computer system of claim 8, wherein the set of non-transitory instructions further cause the processor to:
receive a selection of the task associated with the electronic computing device, wherein the electronic computing device is associated with an application programming interface (API);
access the electronic computing device via an API call to the API; and
receive an API response operation to the API call comprising a status representing a completion progress of the task.

13. The computer system of claim 8, wherein the set of non-transitory instructions further cause the processor to:
generate a graphical user interface (GUI) displaying the allocation of the asset to the class; and
display the GUI on a user device.

14. The computer system of claim 13, wherein the GUI comprises an allocation value, generated by the computer model based on the evaluation data, associated with each class of the set of classes.

15. A computer system comprising:
a machine learning model;
a computer model; and
a processor in communication with the machine learning model and the computer model, the processor configured to:
receive a data packet comprising a set of electronic images associated with an asset;
execute the machine learning model to ingest the set of electronic images and generate a set of attributes, wherein the machine learning model is configured to, for each electronic image in the set of electronic images:
identify a segment of the asset associated with the electronic image;
generate, based on the electronic image, an attribute comprising a description of quality of the segment of the asset; and
determine, based on the attribute, whether the electronic image is associated a subset of the electronic images;
aggregate the set of attributes and an indication of the subset with user input about the asset to generate evaluation data;
execute the computer model to determine an allocation of the asset to a class of a set of classes based on the evaluation data;
determine, based on the class, a task to be executed; and
route the task and the data packet to an electronic computing device associated with the task.

16. The computer system of claim 15, wherein the processor is further configured to:
generate, by the machine learning model based on the electronic image, an output; and
provide the output to a large language model to cause the large language model to generate the attribute.

17. The computer system of claim 15, wherein the attribute comprises a text string indicating a deficiency of the asset associated with the electronic image.

18. The computer system of claim 15, wherein the processor is further configured to:
identify an application programming interface (API) endpoint of an API that associated with the electronic computing device; and
transmit an API call including the data packet that triggers a series of predefined actions associated with the task at the electronic computing device.

19. The computer system of claim 15, wherein the processor is further configured to:
receive a selection of the task associated with the electronic computing device, wherein the electronic computing device is associated with an application programming interface (API);
access the electronic computing device via an API call to the API; and
receive an API response to the API call comprising a status representing a completion progress of the task.

20. The computer system of claim 15, wherein the processor is further configured to:
generate a graphical user interface (GUI) displaying the allocation of the asset to the class; and
display the GUI on a user device.
